(19) United States
(12) Patent Application Publication
(10) Pub. No.: US 2007/0151953 A1
(43) Pub. Date: Jul. 5, 2007

(54) Compressed-gas insulation switching device

(75) Inventor: Manfred Meinherz, Berlin (DE)

Correspondence Address: LERNER GREENBERG STEMER LLP, P O BOX 2480, HOLLYWOOD, FL, 33022-2480, US

(73) Assignee: Siemens Aktiengesllschaft

(21) Appl. No.: 10/587,700

(22) PCT Filed: Jan. 24, 2005
(86) PCT No.: PCT/DE05/00120

§ 371 Date: Jul. 27, 2006

(30) Foreign Application Priority Data
Jan. 30, 2004 (DE) 10 2004 006 062.2

(51) Int. Cl. H01H 33/02

(52) U.S. Cl. 218/155

(57) ABSTRACT

A compressed-gas-insulated switching deviceincludes a grounded encapsulating housing formed of an electrically conductive material and an electrically insulated phase conductor disposed inside the encapsulating housing. First and second flanges are disposed on the grounded encapsulating housing. Insulating housings respectively containing a switch disconnector and an interrupter unit of a power circuit breaker, are connected to the flanges. The insulating housings containing the switch disconnector and the interrupter unit are interchangeable.

The invention relates to a compressed-gas-insulated switching device having a grounded encapsulating housing composed of electrically conductive material, with an electrical phase conductor being arranged in an electrically insulated manner within the encapsulating housing.

By way of example, a compressed-gas-insulated switching device such as this is disclosed in U.S. Pat. No. 6,459,568 B2. The grounded encapsulating housing there surrounds a switch-disconnecting device. One connection of the switch-disconnecting device is connected to an interrupter unit, which is surrounded by an insulating housing, of a circuit breaker. The other connection of the switch-disconnecting device is passed through one wall of the encapsulating housing, by means of an outdoor bushing. The arrangement of a switch-disconnecting device within a grounded encapsulating housing and of an interrupter unit within a housing composed of electrically insulating material means that flexible matching of the known switching device is virtually impossible. By way of example, the interrupter unit of the circuit breaker and the isolating-switching device cannot be directly interchanged.

The object of the invention is to specify a compressed-gas-insulated switching device which can be equipped variably with different appliances.

According to the invention, the object is achieved in that the encapsulating housing has a first and a second flange, in that a first insulating housing, which surrounds an interrupter unit of a circuit breaker, is connected to the first flange via a first coupling housing, in that a second insulating housing, which surrounds a switch disconnector, is connected to the second flange via a second coupling housing, in that a first connecting point of the main current path of the interrupter unit is connected to the phase conductor, in that a first connecting point of the switch disconnector is connected to the phase conductor, in that a second connecting point of the main current path of the interrupter unit is passed to the exterior from the interior of the first insulating housing, and in that a second connecting point of the switch disconnector is passed to the exterior from the interior of the second insulating housing.

The use of a first and a second insulating housing allows the switching device to be designed in a modular form. Furthermore, the proven design of the routing of an electrical phase conductor within a grounded encapsulating housing is retained. In consequence, switching devices according to the invention can also be used as a replacement for traditional dead-tank switches. The use of coupling housings allows matching to different flange diameters in a simple manner. One particularly advantageous feature in this case is that the first and the second flange are of the same physical design with the same dimensions. It is thus possible to reduce the number of different coupling housings.

It is also advantageously possible to provide for a drive device to be coupled to the first coupling housing in order to move a movable contact piece of the switch disconnector.

It is likewise also advantageously possible to provide for a drive device to be coupled to the second coupling housing in order move a movable contact piece of the interrupter unit of the circuit breaker.

The coupling of the drive devices to the respective coupling housings allows the drive movement to be introduced in the immediate vicinity of the contact pieces that are to be moved in the circuit breaker and in the switch disconnector, respectively. There is therefore no longer any need for complex linkages in order to introduce and change the direction of drive movements, for example on the grounded encapsulating housing. This makes it possible to keep the encapsulating housing itself free of drive mechanisms.

One further advantageous refinement can provide for the first insulating housing together with the interrupter unit and the coupling housing, and the second insulating housing together with the switch disconnector and the second coupling housing, to be interchangeable.

The interchangeability of the insulating housings allows different circuit variants to be designed using one and the same encapsulating housing. In particular, it is possible to match the position of the electrical connecting points to already existing switchgear assembly in a highly variable manner without having to modify the design of the switching device itself. It is particularly advantageous for the respective insulating housings and/or the respective coupling housings to be designed to be identical to one another. This reduces the number of different housing groups required to produce a compressed-gas-insulated switching device. The interchangeability also allows different switch disconnectors and circuit breakers with different technical characteristic data to be combined with one another on one switching device.

It is also advantageously possible to provide for a drive shaft to pass through one wall of each coupling housing.

Depending on the drives which are required for the respective switching device, the drive shafts may have different dimensions and may also be in different positions on one of the coupling housings. Only changes to the coupling housing itself for different drives, by virtue of the drive shaft being arranged on the coupling housing, are necessary. Identical insulating housings can be used because there is no need to intervene in the insulating housing.

It is also particularly advantageously possible to provide for the drive devices to be arranged on the outer circumference of the respective coupling housings, and to be supported by the respective coupling housings.

In the same way as the dimensions of the drive shafts, the shapes of the various drive devices may also differ from one another. In this case, depending on the installation position, the locations at which the respective drive devices are fitted to the coupling housing may also differ. All that is necessary for different positions of the drive devices in this case is to match them to the coupling housings themselves. The insulating housings and the encapsulating housing itself remain largely unaffected by such matching designs. This further assists the modularity of the overall design.

One exemplary embodiment of the invention will be described in more detail in the following text and is illustrated schematically in a drawing in which:

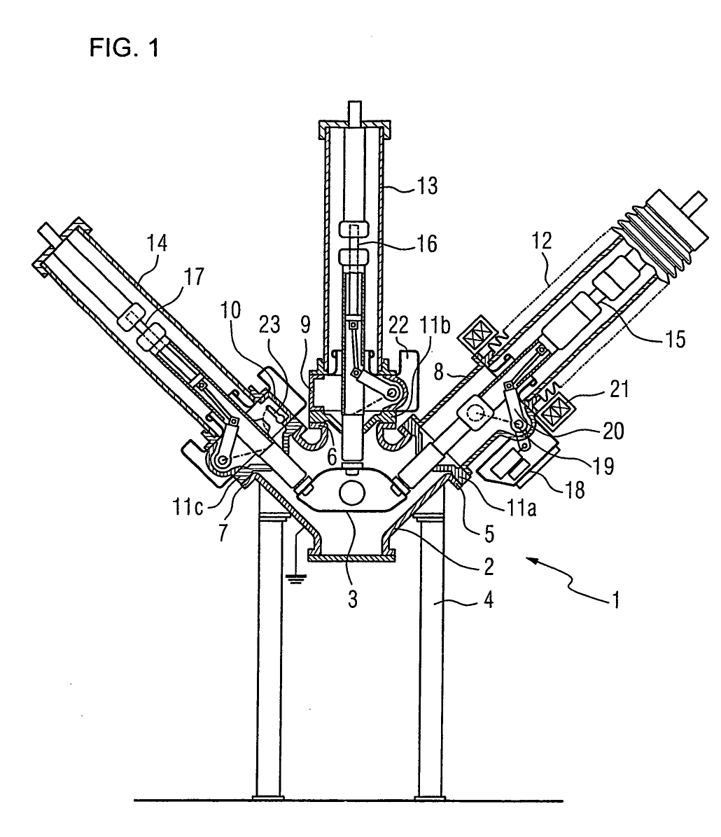

FIG. 1 shows a first embodiment variant of a compressed-gas-insulated switching device, and

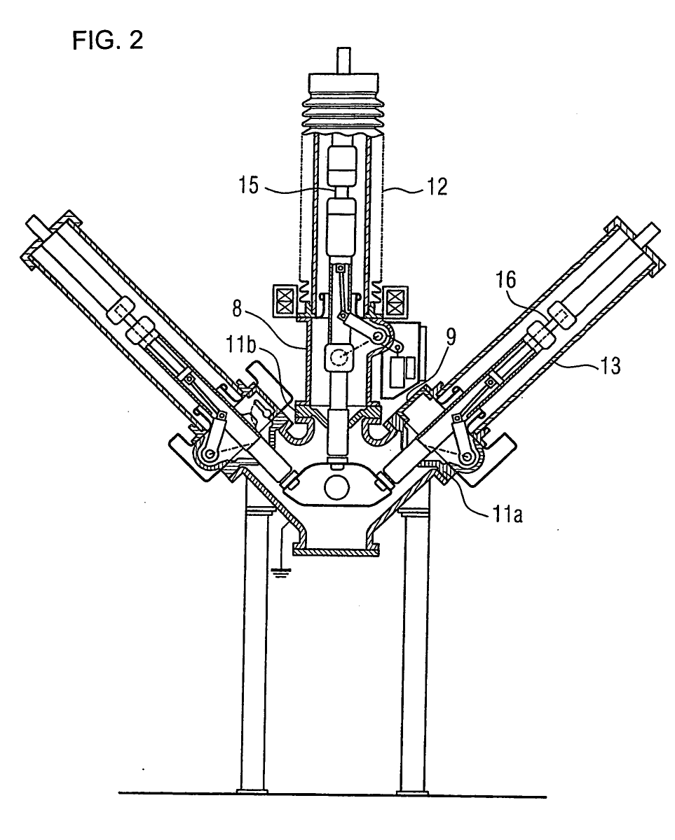

FIG. 2 shows a second embodiment variant of the compressed-gas-insulated switching device.

FIG. 1 shows a first embodiment variant of a compressed-gas-insulated switching device 1. The compressed-gas-insulated switching device 1 has an encapsulating housing 2. The encapsulating housing 2 is manufactured from an electrically conductive material, for example aluminum or steel, and is connected to ground potential. An electrical phase conductor 3 is arranged in the interior of the encapsulating housing 2. The electrical phase conductor 3 is arranged such that it is electrically insulated from the grounded encapsulating housing 2. The encapsulating housing 2 protects the electrical phase conductor against external influences. The encapsulating housing 2 is mounted on a mounting rack 4. The encapsulating housing 2 has a first flange 5, a second flange 6 and a third flange 7. The three flanges 5, 6, 7 advantageously have the same dimensions. A first coupling housing 8 is fitted to the first flange 5. A second coupling housing 9 is fitted to the second flange 6, and a third coupling housing 10 is fitted to the third flange 7. The coupling housings 8, 9, 10 are flange-connected to the flanges 5, 6, 7 with the interposition of a respective insulator 11a, 11b, 11c, which are in the form of disks. Furthermore, a first insulating housing 12 is flange-connected to the first coupling housing 8. Furthermore, a second insulating housing 13 is flange-connected to the second coupling housing 9. A third insulating housing 14 is also flange-connected to the third coupling housing 10. The insulating housings 12, 13, 14 are each essentially cylindrical. An interrupter unit 15 of a circuit breaker is arranged in the interior of the first insulating housing 12, along the cylinder axis. A switch disconnector 16, 17 is in each case arranged on the main axes of the second insulating housing 13 and of the third insulating housing 14. A first connecting point of the main current path of the interrupter unit 15 has a conductor piece which is passed through the disk insulator 11a, and makes contact with the electrical phase conductor 3 within the encapsulating housing 2. A second connecting point of the main current path of the interrupter unit 15 is passed in a gastight manner to the exterior at the free end of the first insulating housing 12. The contact system of the interrupter unit 15 is arranged between the first connecting point and the second connecting point of the main current path of the interrupter unit 15. By way of example, the interrupter unit 15 can be used to disconnect rated currents and short-circuit currents. For this purpose, the interrupter unit 15 is equipped with a movable contact piece, which is not illustrated in any more detail in the figure but which can be moved via a first drive device 18. The first drive device 18 is attached to the outside of the first coupling housing 8. A shaft 19 passes through one wall of the first coupling housing 8 in a gastight manner. Any rotary movement is transmitted via the shaft 19 from outside the first coupling housing 8 into the interior of the first coupling housing 8. A rocker 20 is arranged on the shaft 19 in the interior of the first coupling housing 8. A connecting rod, which is. attached to the rocker 20, converts a rotary movement of the shaft 19 to a linear movement.

This linear movement is transmitted to the movable contact piece. A toroidal transformer 21 is arranged on the first insulating housing 12 in the area of the flange connection of the first coupling housing 8 and the first insulating housing 12, in order to monitor the current flow in the main current path of the interrupter unit 15.

The second insulating housing 13 is flange-connected to the second flange 6 with the interposition of the second coupling housing 9. A second drive device 22 is attached to the second coupling housing 9. Any movement which is produced by the second drive device 22 is introduced into the second coupling housing 9 in a comparable manner to that of the first coupling housing 8. Since, however, the requirements for example relating to the switching rate and the switching frequency for an interrupter unit of a circuit breaker and for a switch disconnector are different, shafts and/or rockers and connecting rods of different dimensions can be used to transmit the drive forces.

A first connecting point of the switch disconnector 16 is passed through the disk insulator 11b with the use of an electrical conductor, and makes contact with the electrical phase conductor 3 in the interior of the encapsulating housing. A second connecting point of the switch disconnector 16 is passed to the exterior from the interior of the second insulating housing 13. The second connecting point of the switch disconnector is passed through at the free end of the second insulating housing 13. The third coupling housing 10, which is flange-connected to the third flange 7, is of a similar design to the second coupling housing 9. In addition, a grounding switch 23 is arranged on the third coupling housing 10. The grounding switch 23 is used to ground the electrical phase conductor 3 via the first connecting point of the switch disconnector 17, that is to say the electrical phase conductor 3, which is mounted in an insulated manner within the encapsulating housing 2, is electrically conductively connected to the encapsulating housing 2, which is at ground potential.

FIG. 2 shows a second variant of a compressed-gas-insulated switching device. Because the first flange 5 and the second flange 6 have the same dimensions, the coupling housings 8, 9 which are flange-connected to them as well as the apparatuses which are also fitted or flange-connected to them are interchangeable. This means that the interrupter unit 15, which is arranged in the first insulating housing 12, of a circuit breaker can be interchanged with the switch disconnector 16 which is arranged in the interior of the second insulating housing 13. In order allow them to be interchanged as quickly as possible, it is possible to provide for the disk insulators 11a, 11b to be in the form of partition insulators by which means the gas area which is formed in the interior of the encapsulating housing 2 is separated from the gas area in the coupling housings 8, 9 and in the insulating housings 12, 13.

As can be seen in the case of the compressed-gas-insulated switching device illustrated in FIGS. 1 and 2, the insulating housings 12, 13, 14 (which are each arranged in the form of rays with respect to one another) together with the coupling housings 8, 9, 10 and the fittings and attachments can thus be interchanged with one another. This results in a flexible compressed-gas-insulated switching device which can be matched very easily to the requirements of the installation location.

1-6. (canceled)

7. A compressed-gas-insulated switching device, comprising:
a grounded encapsulating housing formed of electrically conductive material, said encapsulating housing having first and second flanges;
an electrical phase conductor electrically insulated within said encapsulating housing;
first and second coupling housings;
a circuit breaker interrupter unit;
a first insulating housing surrounding said interrupter unit, connected through said first coupling housing to said first flange and having an interior;
a switch disconnector;
a second insulating housing surrounding said switch disconnector, connected through said second coupling housing to said second flange and having an interior;
said interrupter unit having a main current path with a first connecting point connected to said phase conductor and a second connecting point leading exteriorly from said interior of said first insulating housing; and
said switch disconnector having a first connecting point connected to said phase conductor and a second connecting point leading exteriorly from said interior of said second insulating housing.

8. The compressed-gas-insulated switching device according to claim 7, wherein said switch disconnector has a movable contact piece, and a drive device is coupled to said second coupling housing for moving said movable contact piece.

9. The compressed-gas-insulated switching device according to claim 7, wherein said circuit breaker interrupter unit has a movable contact piece, and a drive device is coupled to said first coupling housing for moving said movable contact piece.

10. The compressed-gas-insulated switching device according to claim 7, wherein said first insulating housing together with said interrupter unit and said first coupling housing, are interchangeable with said second insulating housing together with said switch disconnector and said second coupling housing.

11. The compressed-gas-insulated switching device according to claim 8, which further comprises a drive shaft associated with said drive device and passing through a wall of said second coupling housing.

12. The compressed-gas-insulated switching device according to claim 9, which further comprises a drive shaft associated with said drive device and passing through a wall of first said coupling housing.

13. The compressed-gas-insulated switching device according to claim 10, wherein:
said circuit breaker interrupter unit has a movable contact piece, a first drive device coupled to said first coupling housing for moving said movable contact piece, and a first drive shaft associated with said drive device and passing through a wall of first said coupling housing; and
said switch disconnector has a movable contact piece, a second drive device coupled to said second coupling housing for moving said movable contact piece, and a second drive shaft associated with said drive device and passing through a wall of said second coupling housing.

14. The compressed-gas-insulated switching device according to claim 8, wherein said drive device is disposed on an outer periphery of said second coupling housing and supported by said encapsulating housing.

15. The compressed-gas-insulated switching device according to claim 9, wherein said drive device is disposed on an outer periphery of said first coupling housing and supported by said encapsulating housing.

16. The compressed-gas-insulated switching device according to claim 11, wherein said drive device is disposed on an outer periphery of said second coupling housing and supported by said encapsulating housing.

17. The compressed-gas-insulated switching device according to claim 12, wherein said drive device is disposed on an outer periphery of said coupling housing and supported by said encapsulating housing.

18. The compressed-gas-insulated switching device according to claim 13, wherein said drive devices are each disposed on an outer periphery of a respective one of said coupling housings and supported by said encapsulating housing.
